(19) United States
(12) Patent Application Publication
(10) Pub. No.: US 2013/0226660 A1
(43) Pub. Date: Aug. 29, 2013

(54) Cyclicality-Based Rules for Data Anomaly Detection

(71) Applicants: Lusine Yepremyan, Glendale, CA (US); Amrinder Arora, Centreville, VA (US); Christopher Kakovitch, Herndon, VA (US)

(72) Inventors: Lusine Yepremyan, Glendale, CA (US); Amrinder Arora, Centreville, VA (US); Christopher Kakovitch, Herndon, VA (US)

(21) Appl. No.: 13/594,713

(22) Filed: Aug. 24, 2012

Related U.S. Application Data
(63) Continuation-in-part of application No. 12/717,460, filed on Mar. 4, 2010, now Pat. No. 8,306,943.

(51) Int. Cl. G06Q 30/02

(52) U.S. Cl. CPC G06Q 30/0202
USPC 705/7.31

(57) ABSTRACT

In one example, we describe a method that generates cyclicality rules for anomaly detection for a hierarchical/tree based data structure. A new algorithm for processing nodes in hierarchy, as well as business rules for nodes, is described. Variations and examples are given to describe different scopes and embodiments of the invention. Exclusion criteria and children nodes are used as some examples for the implementations, with flow charts to describe the methods of application, as examples.

### RELATED APPLICATIONS

This application is a CIP (continuation-in-part) of another application at the USPTO, Ser. No. 12/717,460, filed Mar. 4, 2010, now allowed, titled “Seasonality-Based Rules for Data Anomaly Detection”. The corresponding features from the parent case claims priority to the filing date of the parent application Ser. No. 12/717,460. In addition, all the teachings of the parent application Ser. No. 12/717,460, is also included here by reference.

### BACKGROUND OF THE INVENTION

It is well understood within trade industry that products manufactured/shipped out-of-season can have a higher risk of being substandard and/or deteriorating. As a well-known example, apples arriving from Australia in the month of November may be suspect, due to the seasonality of apple harvest in Australia. Similarly, mangoes arriving from California in the month of February may be suspect, due to the seasonality of mango harvest in California. Most of the vegetables, food crops, and fruits show seasonality trends, or cyclicality trends, which can be analyzed for anomaly detection. Industrial products also show seasonality trends, or cyclical trends.

There are notable and understandable exceptions to cyclical rules. For example, some companies in the US have excellent greenhouse operations, and as part of their business model, they ship some tomatoes in winter, to cater to the winter demand of tomatoes.

References for related art include:
1. “Algorithms for Mining Distance-Based Outliers in Large Datasets”, Edwin M. Knox and Raymond T. Ng, Department of Computer Science, University of British Columbia, Vancouver, BC V6T 124 Canada.
2. “Applications of data mining in computer security”, by Daniel Barbara, Sushil Jajodia, Kluwer Academic Publishers, 2002.
3. “Seasonal outliers in time series”, Regina Kaiser and Agustin Maravall, Banco de España Working Papers, 1999.
4. “Distance-based outliers: algorithms and applications”, Edwin M. Knorr, Raymond T. Ng and Vladimir Tucakov, The VLDB Journal, Springer Berlin/Heidelberg, Volume 8, Numbers 3-4/February, 2000.
5. Distance Based Outlier for Data Streams Using Grid Structure, Manzoor Elahi, Lv Xinjie, M. Wasif Nisar and Hongan Wang, Information Technology Journal, 2009, Volume: 8, Issue: 2, Page No.: 128-137.
6. Multiple hierarchical classification of free-text clinical guidelines, Robert Moskovitch, Shiva Cohen-Kashi, Uzi Dror, Iftah Levy, Amit Maimon and Yuval Shahar, Medical Informatics Research Center, Department of Information Systems Engineering, Ben Gurion University, P.O. Box 653, Beer Sheva 84105, Israel.
7. “Greenhouse Tomatoes Change the Dynamics of the North American Fresh Tomato Industry”, at http://postharvest.ucdavis.edu/datastorefiles/234-447.pdf.
8. “Methods for estimating the seasonality of groups of similar items”, http://www.patentstorm.us/patents/6834266.html.
9. “Decision support system for the management of an agile supply chain”, http://www.patentstorm.us/patents/6151582.html.
10. “System and method for detecting traffic anomalies”, http://www.patentstorm.us/patents/6177885/description.html.
11. “Anomaly detection system and a method of teaching it”, http://www.freepatentsonline.com/7613668.html.

However, the invention and embodiments described here, below, have not been addressed or presented, in any prior art.

### SUMMARY OF THE INVENTION

In one embodiment, we describe a method that generates cyclical rules for anomaly detection for a hierarchical/tree based data structure. A new algorithm for processing nodes in hierarchy, as well as business rules for nodes, is described. Variations and examples are given to describe different scopes and embodiments of the invention.

### BRIEF DESCRIPTION OF THE DRAWINGS

FIG. 1 is The Single Node Cyclical algorithm, for one embodiment, as an example.

FIG. 2 is The Exclusion Criteria for trade parties, for one embodiment, as an example.

FIG. 3 is A Method for Generating Child nodes, in a multiple classification hierarchy, for one embodiment, as an example.

### DETAILED DESCRIPTION OF THE PREFERRED EMBODIMENTS

Here, in one embodiment, we show how to formulate the problem:

We are given source data consisting of product, associated trade parties and date of activity. The date of activity can be the date of growth/manufacturing or the date of shipping. An example of data can be found here, in Table 1:

TABLE 1
Data sample of products, associated parties, and frequency:

| | Associated | | | |
|---|---|---|---|---|
| | Trade | Associated | | Activity |
| Product | Party 1 | Trade Party 2 | Quantity | date |
| Cucumber | ABC | Mexico | 100 kg | Jun. 22, 2009 |
| | Grower | | | |
| Broccoli | XYZ | Honduras | 40 MTon | Jul. 3, 2009 |
| | Grower | | | |
| Apples, | BCD | Nicaragua | 50 sacks | Mar. 15, 2009 |
| Gala | Grower | | | |
| Apples | Happy | Mexico | 2 containers | Mar. 24, 2009 |
| | Farmer | | | |
| Apples, | BCD | Nicaragua | 60 sacks | Apr. 20, 2009 |
| Granny | Grower | | | |
| Smith | | | | |

Assume we have a dataset of objects, each having n attributes that belong to their corresponding classes. Hierarchical or not, the dataset can be represented as a tree in the following way: The root node that has no incoming edges represents the entire dataset. Following the root node are level-one nodes, which are generated based on class1 attributes. The n-th generation (or level-n) nodes are leaf nodes with no outgoing edges, and they represent a particular object from a dataset, not a group of objects. Each node has the following statistics or parameters: average frequencies by cyclical term (S₁ to Sₖ), and Max, Min, and Median of Sᵢ through Sₖ.

Proposed System and Methodology:

Notations:
Product p
qₚsᵢ: Quantity of a product for a given cyclical term Sᵢ
Sp=Sum(qₚs₁ to qₚsₖ)
Xp=Max(qₚs₁ to qₚsₖ)
Np=Min(qₚs₁ to qₚsₖ)
Dp=Median(qₚs₁ to qₚsₖ)

Cyclicality is defined as a more general notion to seasonality. Unlike Seasonality, Cyclical terms do not have to be all consistent across cycles. Terms can be caused by combinations of different events. A certain term for a certain time period T1, can be divided into T11 to T1N terms, each of which consisting of other combinations or being left as is. Thus, one cycle can be divided into other non similar sub-cycles, and so on.

Business Rules:

Criteria C0 (Statistically Significant Data):

If Sp>Threshold T.

This is the criteria for the node (and subsequently children nodes) not to be eliminated from processing. (Specifically, if Sp>Threshold T, only then we consider that node (and possibly its child nodes). If Sp<=T, then we drop the node and its child nodes altogether.)

Criteria C1 (Strong Cyclicality):

If X_{P}/N_{P}>G₁ (e.g. G₁=100)

Treatment T1: For each cycle Sᵢ, give a risk increment of f(Sᵢ,D_{P}), wherein f( . . . ) is a function.

This is the criteria for the children of the node to be eliminated from processing.

Criteria C2 (Weak Cyclicality):

If X_{P}/N_{P}>G₂ (e.g. G₂=4). This is the criteria when the node and the child nodes are still eligible for further processing.

Obviously, G₁ must be greater than G₂.

Treatment T2: For each cycle Sᵢ, give a risk increment of g(Sᵢ,D_{P}), wherein g( . . . ) is a function. The treatment T2 is (in general) different from that of T1, but they can be the same in some situations. In general, the weak cyclicality implies that the risk increment of g(Sᵢ,D_{P}) is not the same order of magnitude as that of f(Sᵢ,D_{P}).

The Cyclicality Algorithm:

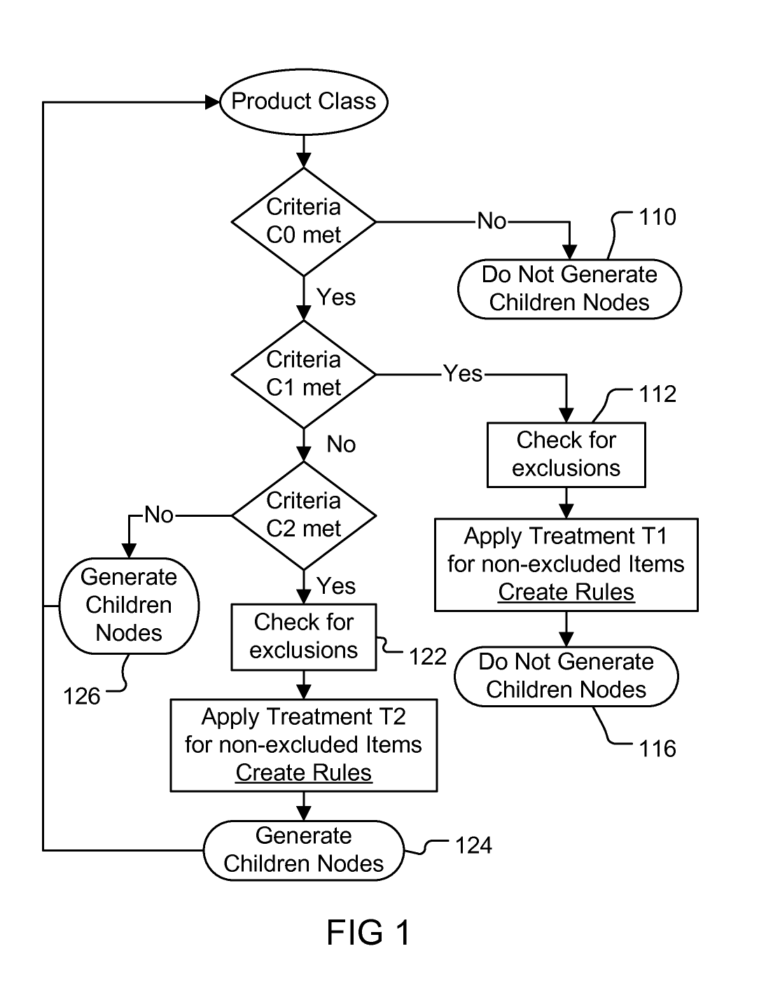

We start the process from the parent node (root node, as a starting point) and continue with all the nodes on the same level until all the eligible nodes have been considered. Then, we continue with their child nodes, until we reach all leaf nodes. All children nodes go to the same process called Single Node Cyclicality Algorithm. The process for each node is described in FIG. 1, The Single Node Cyclicality Algorithm.

Often times in practice, it will not be necessary to aggregate all the products in the same hierarchy. Sometimes, it is more reasonable to find the highest common ancestor, for example, in case of fruits and vegetables, it will be food. To do that, we will track all the products up in the hierarchy so we can find the node in the tree which is the lowest in the hierarchy, but contains all the products of interest (e.g. food). We will consider that node to be the parent node.

Checking for Exclusions:

Check for exclusion process checks to see if the corresponding criterion for a given node is not met by trade parties. If it is not met, then we do not have to apply the corresponding treatment for that subsection.

Criteria C3 (The Exclusion Criteria):

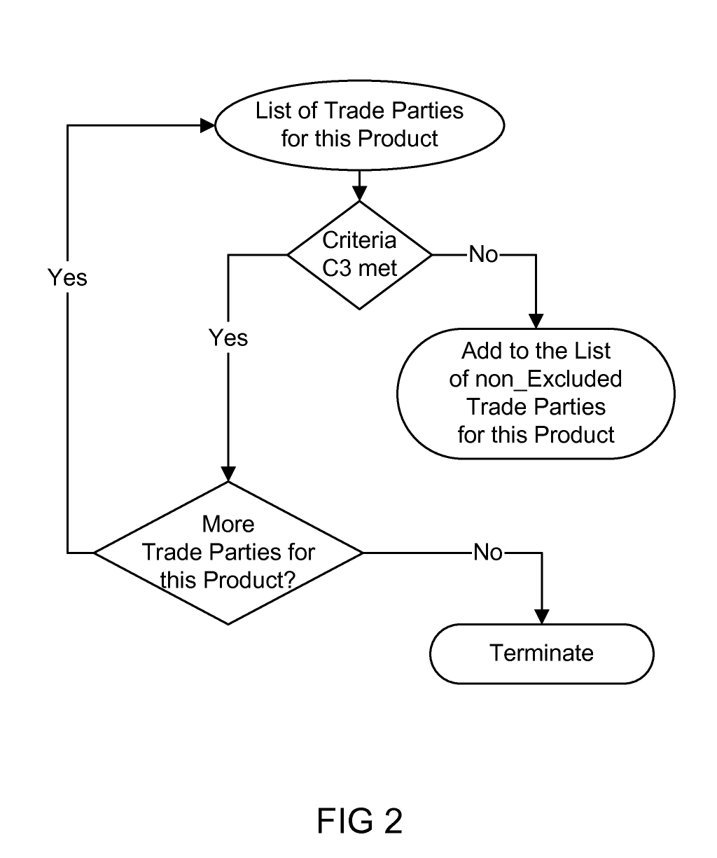

The exclusion is said to be held, if the trade party has history with this product, and this cycle's quantities for this trade party are similar to previous cycle's quantities for this trade party. Similarity to previous cycle, in terms of quantities, is defined as deviating/exceeding from previous cycle's quantities by no more than a factor of 2 (or a factor R_{f}, a real number, in general). (The Exclusion Criteria for trade parties is described in FIG. 2.)

Comparison to the prior parameters can also be done using percentages and differences, in relative or absolute values, and also using the neural network method, to find the differences, to train to compare with thresholds, for history on record, in memory units, to find the samples that are beyond the threshold, which should be excluded, deleted, or ignored.

Generating Children Nodes:

Navigating a multiple classification hierarchy can be done by using each level's Information Value. For each candidate child node, we calculate the following statistics:

For each attribute k of the class i, calculate IVᵢₖ=(Spᵢₖ*Xpᵢₖ/Npᵢₖ)/log(n), where Spᵢₖ is the sum of quantities for an attribute k of the class i, nᵢ is the number of attributes of the class i, Xpᵢₖ and Npᵢₖ are Min and Max of quantities for an attribute k of the class i. Denote IVᵢ (Information Value) as the sum of all IVᵢₖ of existing attributes.

The Xpᵢₖ/Npᵢₖ (the max over min ratio) is a determinant of the attributes for cycle, and hence, it goes into the formula for IV (the bigger the ratio, the higher its contribution to the IV value). Spᵢₖ (sum of quantities for an attribute k) serves as a weight factor of the attribute on IV calculation. Thus, if an attribute has small number of quantities, then the weight of max/min ratio is small, as well. The (Spᵢₖ*Xpᵢₖ/Npᵢₖ) value will contribute to IV greatly, if we see both high cyclicality and high number of elements. And, finally, we divide the weighted ratio to log(nᵢ) to reduce the IV value for the cases when the number of attributes in a class is too many. This reduces the complexity of the hierarchy.

Of course, the weight can be defined differently, to show the magnitudes of max or min, in an alternative, and a normal real number, rather than log-scale, can be used, to express the values and concepts above, in a different scale.

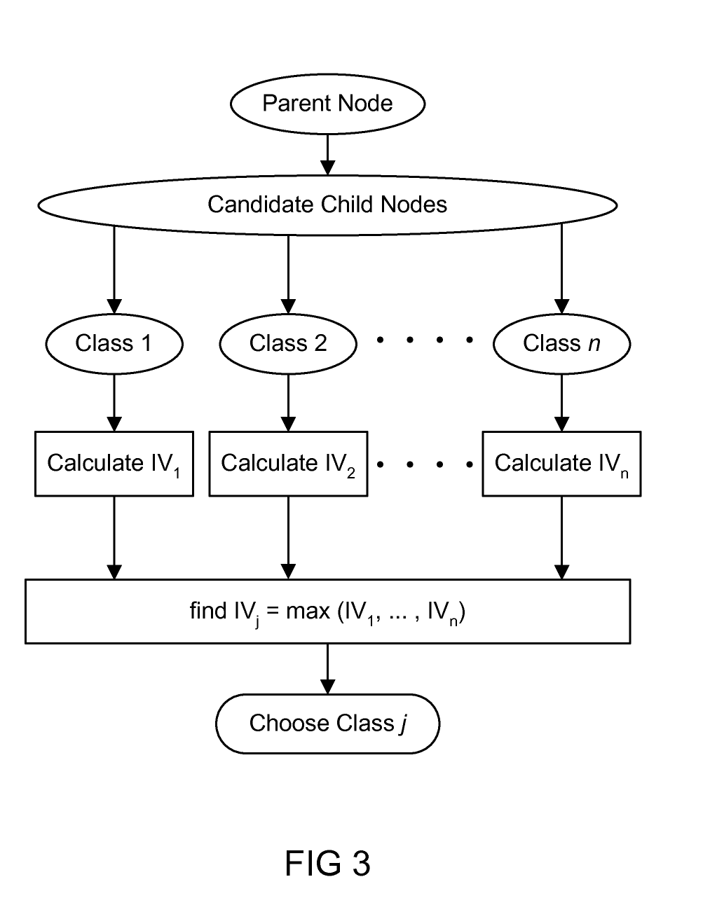

The class level that gives the highest IV should be chosen as a child node, as shown in FIG. 3, for generating child nodes, in a multiple classification hierarchy.

The cycle is defined as a period of time or multiple periods of time/windows T1, in which some parameter P1 has a value of M11, and in the other periods, T2, T3, etc, P1 has the value of M12, M13, etc. Similarly, for a parameter P2, we will have (for periods T1, T2, T3, . . . ) values of M21, M22, M23, etc, respectively. This constitutes a matrix of H by Q, in which we have H different kinds of parameters (or P), and (maximum possible number for) Q different kinds of windows or time or periods (or T). This gives the relationship between all P and T, with resulting M (values) in the matrix form, for the corresponding columns and rows, represented by Mij, with i and j representing row and column numbers, respectively, in the matrix, as the index for element M in the matrix.

Other parameters that can be used, in other embodiments, for measuring or quantizing degree of abnormality, being out-of-cycle, or anomaly, is based on difference between maximum and minimum for a parameter, the range of 25 percent and 75 percent percentile values for a parameter, or one or 2 standard deviations from mean or average for a parameter. Then, assuming a normal distribution or a similar distribution, the further one gets away from the mean or average, the more abnormal it gets, using a metrics or parameter for quantization or comparison, with a real number normalized between 0 to 100, or between 0 and 1 range, as an example for showing the degree of abnormality or being different from norm or average, as one way to quantify the degree or level of being different, or difference to average or mean. The values or distances are compared or subtracted from each other, and can be divided to the base or original value, to normalize them, for comparisons, or scaling, as an example, to get ratios or percentages.

One can, in one example, subtract or delete the “understandable exceptions”, as mentioned above, from the “total” list of exceptions, to get the “net” list of exceptions, for further processing, in our system here.

The Concept of seasonality and cyclicality has applicability in the following:
CBP—Border Crossings of people for seasonal work—past trends could/should predict volumes and thus future trends and patterns allowing for better resource alignment and bad actor detection.
ICE—There are cycles relevant to interdiction of certain individuals and groups engaged in crimes. Further, there might be an opportunity to build seasonally based models that would aid in resource allocation as ICE struggles with the backlog of Visa overstays and the concomitant crimes perpetrated by these individuals.
OCDETF—similar to ICE

For Finance/Regulatory:
FinCEN—cyclicality regarding cross-border financial transactions, i.e., past actions could be seen as a predictor of appropriate volumes, and outlier transactions could be better detected.
IRS—in the LB&I and SB/SE sectors, business filings follow a seasonal/cyclical pattern. Past cycles could be modeled to provide a baseline for benign activities, thus allowing for better detection of outliers, and thus resource deployment toward issues of materiality.
IRS—in W&I and OCA realms, cycles can again be used to put a baseline of appropriate individual filing behaviors, and thus allow for better detection of fraudulent trends, and perhaps aid in the Identity Theft modeling activities.
State tax agencies would benefit in a similar fashion.
FDIC and OCC—Cycles are inherent in the filings that these agencies review, to discern health of individual transactions. Models could be developed that provide a baseline of expected behaviors, and thus allow for better detection of negative trends in the avalanche of filings received each period.
OFR—as they are charged with monitoring “Systemic Risk,” there will be cyclical patterns that will definitely be harbingers of risk associated with related entities in the complex financial institution arena. For example, a heavy position in commodities could be modeled against previous commodity cycles to ascertain heavy risk across a group of banks in the “too big to fail” sector.

For IC/DoD:
Seasonal models could be highly useful in the IED and insurgency realms. Baseline models could aid in detection of anomalies that would be viewed as harbingers of potential new threats and allow for proactive resource alignment.
DoD—logistical preparations and modeling are highly influenced by seasonal trends, which is an opportunity for seasonally-based models that allow for better reaction and resource alignment.

Our system has a central processing unit, in one example, along with multiple storage units, with some user input interface/unit, and communication units between processing module and other modules, e.g. comparison module, exception module, and security module, e.g. doing various tasks shown in FIGS. 1-3, above.

One example: The criteria are stored in first storage unit(s), and parameters are input by a user or from a second storage unit or database/list. The comparisons are done by a system, processor, computer, or microprocessor. The exclusion results and generation of children nodes are done by application or secondary processor unit. The hierarchy and nodes are stored in a memory unit or third storage, as an example. The modules are connected through buffers or other memory units, with another processor directing all the data transfer and actions. One can combine processors and memory units, in one or fewer units, if desired, in another embodiment.

Any variations of the above teaching are also intended to be covered by this patent application.

1. A method for anomaly detection, using cyclicality based rules, said method comprising:
a first central processing unit receiving a set of parameters for a manufactured or shipped product;
obtaining a set of criteria from a first storage unit;
with respect to a product class, said first central processing unit examining a first criteria to see if said first criteria is met;
if said first criteria is met, then said first central processing unit examining a second criteria to see if said second criteria is met; and
if said first criteria is not met, then said first central processing unit disabling children node generation, which refers to generating an information value level for a classification hierarchy; and
if said second criteria is met, then said first central processing unit checking for exclusions, applying a first treatment for non-excluded items from a second storage unit, and creating rules and disabling children node generation;
otherwise, if said second criteria is not met, then said first central processing unit examining a third criteria to see if said third criteria is met; and
if said third criteria is not met, then said first central processing unit generating children nodes for the hierarchy, and returning said generated children nodes to said product class stored in a third storage unit; and
if said third criteria is met, then said first central processing unit checking for exclusions, applying a second treatment for non-excluded items from said second storage unit, and creating rules and generating children nodes, and returning said generated children nodes to said product class stored in said third storage unit.

2. The method for anomaly detection, using cyclicality based rules, as recited in claim 1, further comprising:
examining for existence of strong cyclicality or weak cyclicality.

3. The method for anomaly detection, using cyclicality based rules, as recited in claim 1, further comprising:
monitoring systematic risk.

4. The method for anomaly detection, using cyclicality based rules, as recited in claim 1, further comprising:
receiving a list of trade parties.

5. The method for anomaly detection, using cyclicality based rules, as recited in claim 1, further comprising:
adding to a list of non-excluded trade parties.

6. The method for anomaly detection, using cyclicality based rules, as recited in claim 1, further comprising:
examining if there are more trade parties.

7. The method for anomaly detection, using cyclicality based rules, as recited in claim 1, further comprising:
terminating a process.

8. The method for anomaly detection, using cyclicality based rules, as recited in claim 1, further comprising:
generating a tree or hierarchical structure.

9. The method for anomaly detection, using cyclicality based rules, as recited in claim 1, further comprising:
generating a parent node.

10. The method for anomaly detection, using cyclicality based rules, as recited in claim 1, further comprising:
determining a baseline.

11. The method for anomaly detection, using cyclicality based rules, as recited in claim 1, further comprising:
assigning or choosing a class.

12. The method for anomaly detection, using cyclicality based rules, as recited in claim 1, further comprising:
considering N different classes, wherein N is an integer bigger than 1.

13. The method for anomaly detection, using cyclicality based rules, as recited in claim 1, further comprising:
calculating a first value for each attribute of a class.

14. The method for anomaly detection, using cyclicality based rules, as recited in claim 1, further comprising:
determining a maximum value of a set of second values.

15. The method for anomaly detection, using cyclicality based rules, as recited in claim 1, further comprising:
determining values beyond one or more thresholds.

16. The method for anomaly detection, using cyclicality based rules, as recited in claim 1, further comprising:
determining anomalies.

17. The method for anomaly detection, using cyclicality based rules, as recited in claim 1, further comprising:
determining odd shipments at a custom office.

18. The method for anomaly detection, using cyclicality based rules, as recited in claim 1, further comprising:
reexamining odd shipments at a custom office.

19. The method for anomaly detection, using cyclicality based rules, as recited in claim 1, further comprising:
generating cyclicality rules.

20. The method for anomaly detection, using cyclicality based rules, as recited in claim 1, further comprising:
aggregating reports for two or more trading parties.
